(19) United States
(12) Patent Application Publication
(10) Pub. No.: US 2015/0202835 A1
(43) Pub. Date: Jul. 23, 2015

(54) CORRUGATED ALUMINUM FOIL BOARD

(71) Applicant: Bruce L. Finn, Malibu, CA (US)

(72) Inventor: Bruce L. Finn, Malibu, CA (US)

(21) Appl. No.: 14/515,350

(22) Filed: Oct. 15, 2014

Related U.S. Application Data
(63) Continuation of application No. 13/301,714, filed on Nov. 21, 2011, now abandoned.
Application No. 13/301,714 is a continuation of application No. 12/344,201, filed on Dec. 24, 2008, now abandoned.
(60) Provisional application No. 61/017,048, filed on Dec. 27, 2007.

(51) Int. Cl. B32B 3/28; F21V 7/16; G03B 15/06; B32B 15/01

(52) U.S. Cl. CPC B32B 3/28; B32B 15/016; F21V 7/16; G03B 15/06; B32B 2250/03; B32B 2307/3065; B32B 2307/306; B32B 2551/00

(57) ABSTRACT

A corrugated aluminum foil board has one or more sheets of aluminum foil corrugated, ridged, or bent in a wave-like or folded pattern to achieve increased rigidity, and sandwiched between aluminum foil sheets to form a strong and rigid material composition resembling metallic cardboard. The shaped sheets may be assembled by using a non-flammable glue, or by welding or otherwise fastened or fused, to create a generally rigid, lightweight, and fire resistant material with many advantages for the entertainment industry with respect to motion picture or television lighting, and other uses.

### RELATED APPLICATION INFORMATION

This application is a continuation of U.S. application Ser. No. 13/301,174, filed Nov. 21, 2011, which is a continuation of U.S. application Ser. No. 12/344,201, filed Dec. 24, 2008, which claims the benefit of U.S. Provisional Application Ser. No. 61/017,048, filed on Dec. 27, 2007, hereby incorporated by reference as if set forth fully herein.

### BACKGROUND OF THE INVENTION

1. Field of the Invention

The field of the present invention generally relates to a sheet material composition and objects manufactured therefrom, such as snoots, flags, bounce boards, light boxes and other devices designed to block, contain, reflect, direct or control light for motion picture or photographic use.

2. Background

In the entertainment industry including motion pictures, television and theatrical arts, as well as in the photographic industry and other fields it is necessary to light a set, stage or other area. Often the light produced from the available instruments needs to be shaped, softened, bounced, contained or controlled to make the most desirable picture.

Conventional wisdom is to use Fome-cor® extruded polystyrene foam sheets laminated between two 12-point clay-coated paper liners or other variations or similar materials (including “poly” polystyrene board) to fashion snoots, flags, bounce boards, light boxes and other devices to attain the desired light modification and control.

These materials have the advantageous properties of an “Art Board”—that is, easy to cut (e.g., with a razor knife), score, bend and shape. These materials are also rigid and lightweight, with several choices of thickness and surface combinations (including black and white).

Other products such as fabrics like duvatyne and ultra bounce, commercially manufactured flags, frames with grifflon or lames stretched on them, aluminum foil sometimes painted or anodized black, and other methods of controlling/modifying light are also sometimes used in the entertainment industry. Drawbacks of these materials when compared to Fome-cor or the like for many purposes include not being rigid, foldable, or easily cut, shaped and formed, or having inappropriate weight, size, etc. The various properties of the foam board as previously described makes it well suited for use in the entertainment field.

Unfortunately, there is a major flaw in the use of this “Art Board” for lighting in the entertainment industry: the material's flammability. The material appears to combust quite rapidly, which is a serious concern as it is often used in close proximity to hot motion picture lights. There have been numerous fires on motion picture and television sets in the past decade now that use of these materials has become commonplace. When heated or burning, these foam board materials can drip hot material and give off dangerous gases. The structural integrity under heat is also an issue as well as changing form due to being composed of material(s) that are effected by heat.

Another concern with foam boards is the fact that they are non-biodegradable, and thus have an adverse impact on the environment.

Recent “flame resistant” foam boards have been made that are designed not to continue to burn where the source of the flame is removed, and to resist ignition and combustion. While addressing the problem of fire is a step in the right direction, utmost safety is not achieved with these materials. Cost of these flame resistant foam boards also may be significantly higher than prior foam boards.

Other attempts to overcome the flammability problem of conventional foam boards involve covering the foam board surfaces with foil. However, this does not necessarily solve the problem of heat-induced warpage or potential flammability. Also, making custom foil-covered foam boards is labor-intensive and expensive.

What is needed is a product that has the useful properties of the foam board, including rigidity and lightness in weight, that is easily cut, scored and shaped, with several available thicknesses, yet without the dangerous properties of being made from polystyrene foam and paper which are both combustible. An ideal material would be, among other things, highly heat and fire resistant, and made from recycled materials and/or itself recyclable.

### SUMMARY OF THE INVENTION

In one or more embodiments, a corrugated aluminum foil board is provided that may find use in the entertainment field to fashion snoots, flags, bounce boards, light boxes, etc., for use in proximity to hot motion picture or television lights while improving safety greatly through improved fire and heat resistance.

In an embodiment, a corrugated aluminum foil board material may be manufactured of one or more sheets of woven, bent or folded aluminized material, much like cardboard. An aluminum foil (or other similar sheetlike material) is preferably corrugated or bent in a wave-like or folded pattern to achieve increased rigidity. One or more sheets of this shaped material, or materials, may be layered at intersecting or crossing angles and, if desired, sandwiched between flat foil or other material. The shaped sheets may be assembled by using a non-flammable glue, or by welding or otherwise fastened or fused, to create a generally rigid, lightweight, and fire resistant material with many advantages for the entertainment industry and possibly other uses.

In certain embodiments, the versatility of the corrugated aluminum foil board may be enhanced by modifying the exposed surface of the board. Different surface colors, patterns and/or materials may be utilized for the surface, thus modifying the quality and reflection of light and heat in an advantageous way, such as an aluminum surface that could be hard or soft (possibly variegated) silver, gold, blue etc, as well as more conventional black or white. Various lighting effects can be achieved by texturing, laminating, dying, painting or anodizing the outer surface(s) of the resulting aluminum foil board. Perforation of the board may be advantageous in certain applications—for example, to reduce weight and/or allow wind to pass through for outdoor reflector type use. The fact that the basic material is waterproof and an efficient reflector/absorber/radiator of light/heat energy may allow the resulting foil board structure to have significant other uses in packaging, fluorescent light housings, model making or other applications. Variations in the direction of the corrugated wafers might also be used to control rigidity for various applications. It may also be advantageous to incorporate aluminum (or other) wires to increase strength or mold ability. Introduction of PVC or other materials may be advantageous to reduce electrical conductivity, control audible properties, or modify other attributes.

It may also be advantageous to make the aluminum foil board material/product in a form that can “roll up”. For example, by providing ridges (or scores) along only one length, it would be possible to roll up the material for shipping or storage. Affixing (e.g., sandwiching) two or more pieces together with the ridges juxtaposed would create a rigid and flat “board ” when affixed but a compact rolled up material when not affixed. Such ability to roll up the material could also be advantageous in creating cylindrical shaped “snoots” for use to shape the light from a lighting instrument.

An aluminum foil board made according to embodiments as described herein may be used, for example, to fashion snoots, flags, bounce boards, light boxes and other devices needing a lightweight, rigid, easily cut and shaped fire-resistant material to block, contain, reflect, direct or control light for motion picture or photographic use.

Further variations, modifications and enhancements are also described herein.

### BRIEF DESCRIPTION OF THE DRAWINGS

FIG. 1A is a diagram of a partial cutaway front view of a corrugated aluminum foil board in accordance with one embodiment as disclosed herein, and FIG. 1B is a cross sectional side view of the same.

FIG. 2A is a diagram of a partial cutaway front view of a corrugated aluminum foil board in accordance with another embodiment, and FIG. 2B is a cross sectional side view of the same.

FIG. 3 is a diagram showing different surface textures or variations of an aluminum foil board.

FIG. 4 is a diagram of a partial cutaway view of an aluminum foil board pair showing corrugation in one direction (or slit) so that it is rollable, with the two foil boards being fastenable at juxtaposed angles to create rigidity. Different surfaces are shown to illustrate use as a variable surface reflector.

FIG. 5A is a side view diagram of an aluminum foil board that has been rolled into a more compact size.

FIG. 5B is a side view diagram of an aluminum foil board that has been rolled into the shape of a snoot, and FIG. 5C shows the rolled snoot of FIG. 5B attached to a lighting fixture.

FIGS. 6A and 6B are side and front view diagrams, respectively, showing a generally box-shaped snoot fashioned from a rigid aluminum foil board and attached to a yoke-mounted multi-light lighting fixture.

FIG. 7 is an oblique diagram showing further details of a central aluminum sheet core as may be used in various embodiments of an aluminum foil board.

FIGS. 8A and 8B are oblique view diagrams showing a corrugated aluminum foil board with smooth side sheets and variegated side sheets, respectively.

FIG. 9 is a diagram of a reinforced aluminum sheet as may be used in an aluminum foil board in various embodiments.

FIG. 10 is a diagram of an aluminum sheet with air-filled aluminum bubbles as may be used in an aluminum foil board in various embodiments.

### DETAILED DESCRIPTION OF PREFERRED EMBODIMENTS

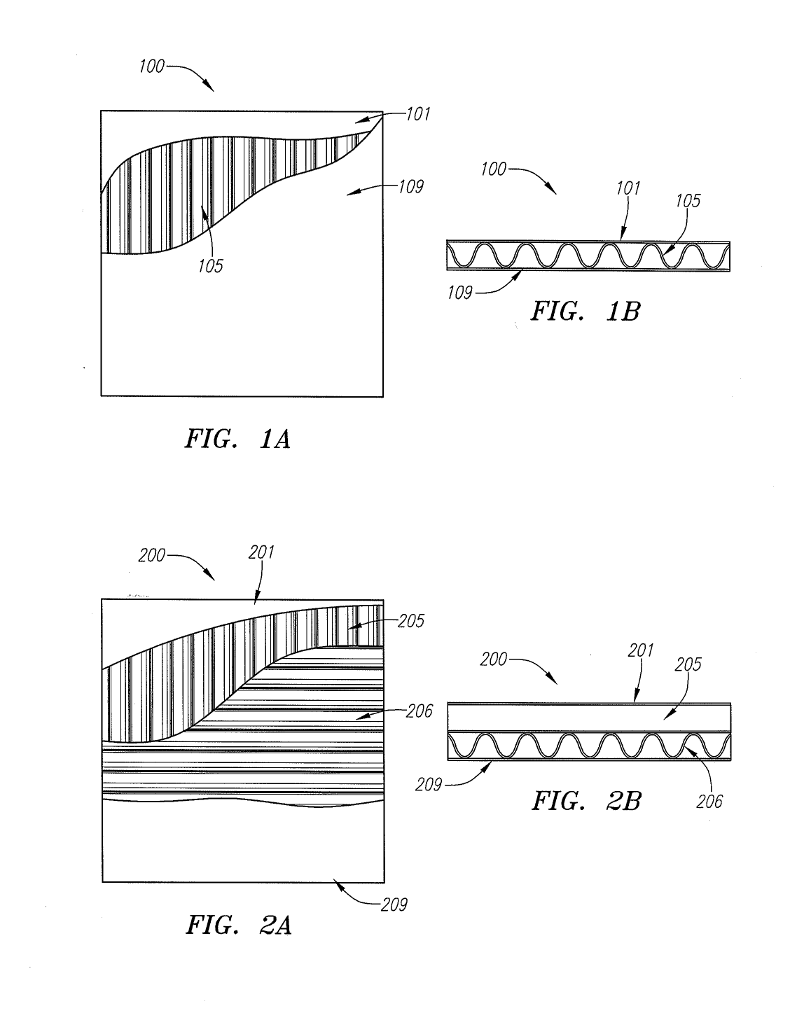

FIG. 1A is a diagram of a partial cutaway front view of a corrugated aluminum foil board 100 in accordance with one embodiment as disclosed herein, and FIG. 1B is a cross sectional side view of the same.

In FIG. 1A, the corrugated aluminum foil board 100 comprises a first outside layer 101 of flat aluminum foil, a middle layer 105 of corrugated, bent or folded aluminum foil, and a second outer layer 109 of flat aluminum foil, arranged such that the middle layer 105 is sandwiched between the first outside layer 101 and second outside layer 109 of aluminum foil. The outside layers 101, 109 may be affixed to the middle layer 105 by welding, heat-resistant adhesive, or other means. The middle layer 105 is preferably corrugated, similar to cardboard, or else woven, bent or otherwise folded in a wave-like or other pattern to achieve increased rigidity. FIG. 1B shows a side view of the aluminum foil board 100. The middle layer 105 may include one or more sheets of aluminum foil material. The inventor has found that despite the relative flimsiness of aluminum foil, when the foil is corrugated (as the middle layer 105) and sandwiched between two foil sheets (as outside layers 101, 109), the resulting structure is surprisingly and unexpectedly rigid and firm, and capable of self-support. The aluminum foil board 100 resulting from this structure forms a generally rigid, lightweight, and fire resistant composite structure that may be shaped or rolled, with many advantages for use as lighting fixture accessories or for other applications.

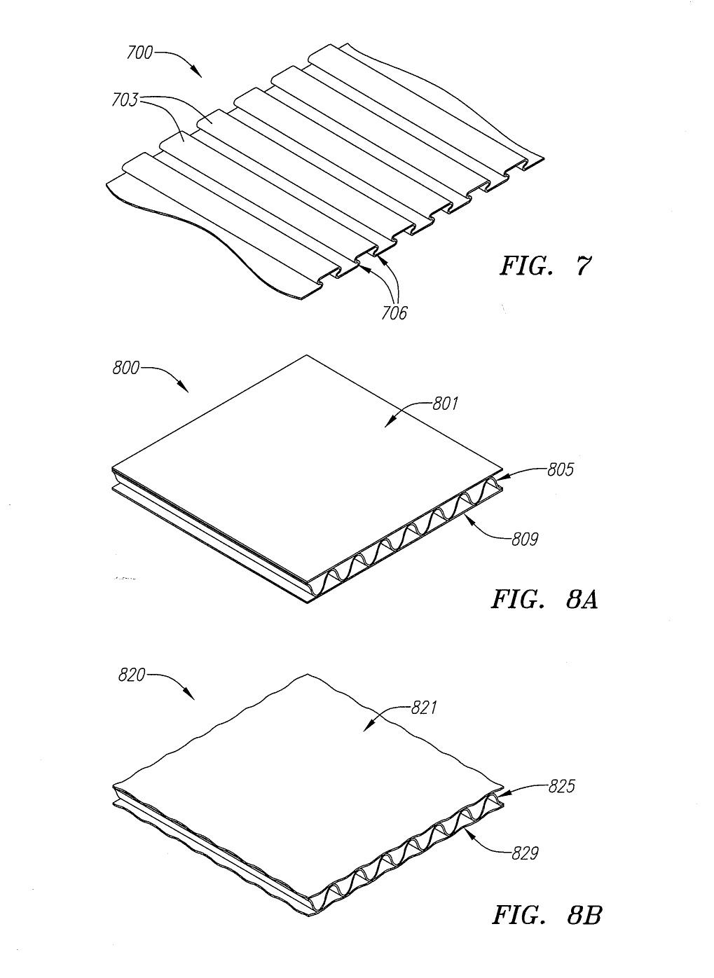

The pattern of corrugations, folds, creases or other similar features in the central aluminum sheet core is preferably repeating and regular, with a sufficient number of features to provide structural support for the aluminum foil board. For example, a repeating feature every ½″ to ¾″ inch may generally be sufficient to provide the desired structural support for an aluminum foil board in many applications. FIG. 7 is an oblique diagram showing further details of a central aluminum sheet core 700 as may be used in various embodiments of an aluminum foil board, such as the aluminum foil board 100 of FIG. 1A. In FIG. 7, an aluminum sheet has been repeatedly folded into a series of overlying folds 703, each having a pair of overhanging creased edges 706. In other examples, the folds 703 may be flattened or flatter as compared to FIG. 7, or may be double-folded (or more) or else folded to one side, or otherwise formed into a repeating patterned structure having similar qualities. The term “corrugated” as used herein is intended to encompass various folded, ridged, grooved, wave-like or other similar patterns achieving increased rigidity of the otherwise relatively flimsy foil sheet. The aluminum foil may be corrugated by any of a number of means, including potentially using a corrugating machine similar to those used to make corrugated cardboard.

The outside sheets of the foil board may also take various forms or have different textures. FIGS. 8A and 8B are oblique view diagrams showing a corrugated aluminum foil board with smooth side sheets and variegated side sheets, respectively. Thus, in FIG. 8A, the outside layers 801, 809 of aluminum foil are both smooth, whereas in FIG. 8B, the outside layers 821, 829 of aluminum foil are wavy or slightly crinkled or creased. The different textures of the outside layers provide a variety of different options for modifying or adjusting illumination from a lighting fixture on, e.g., a motion picture of television studio set.

FIG. 2A is a diagram of a partial cutaway front view of a corrugated aluminum foil board 200 in accordance with another embodiment, and FIG. 2B is a cross sectional side view of the aluminum foil board 200.

In FIG. 2A, the corrugated aluminum foil board 200 comprises a first outside layer 201 of flat aluminum foil, a first middle layer 205 of corrugated, bent or folded aluminum foil, a second middle layer 206 of corrugated, bent or folded aluminum foil, and a second outer layer 209 of flat aluminum foil, arranged such that the middle layers 205, 206 are sandwiched between the first outside layer 201 and the second outside layer 209 of flat aluminum foil. The various layers 201, 205, 206 and 209 may be affixed to one another by welding, heat-resistant adhesive, or other means. The middle layers 205, 206 may each be corrugated, similar to cardboard, or else woven, bent or otherwise folded in a wave-like or other pattern to achieve increased rigidity. The direction of the corrugated pattern for the first middle layer 205 is preferably perpendicular to the direction of the corrugated pattern for the second middle layer 206, so that the ensuing structure is rigid in both directions, and thus making the aluminum foil board 200 of this embodiment resistant to bending or rolling. FIG. 2B shows a side view of the aluminum foil board 200. Each of the middle layers 205, 206 may include one or more sheets of aluminum foil material. The inventor has found that despite the relative flimsiness of aluminum foil, when the foil is corrugated in perpendicular directions (as the middle layers 205, 206) and sandwiched between two foil sheets (as outside layers 201, 209), the resulting structure is surprisingly and unexpectedly rigid and firm, even more so than when a single middle layer is used (as in FIG. 1A). The aluminum foil board 200 resulting from this structure forms a generally rigid, lightweight, and fire resistant composite structure that may be shaped or interconnected into larger shapes (boxes, etc.), with many advantages for use as lighting fixture accessories or for other applications.

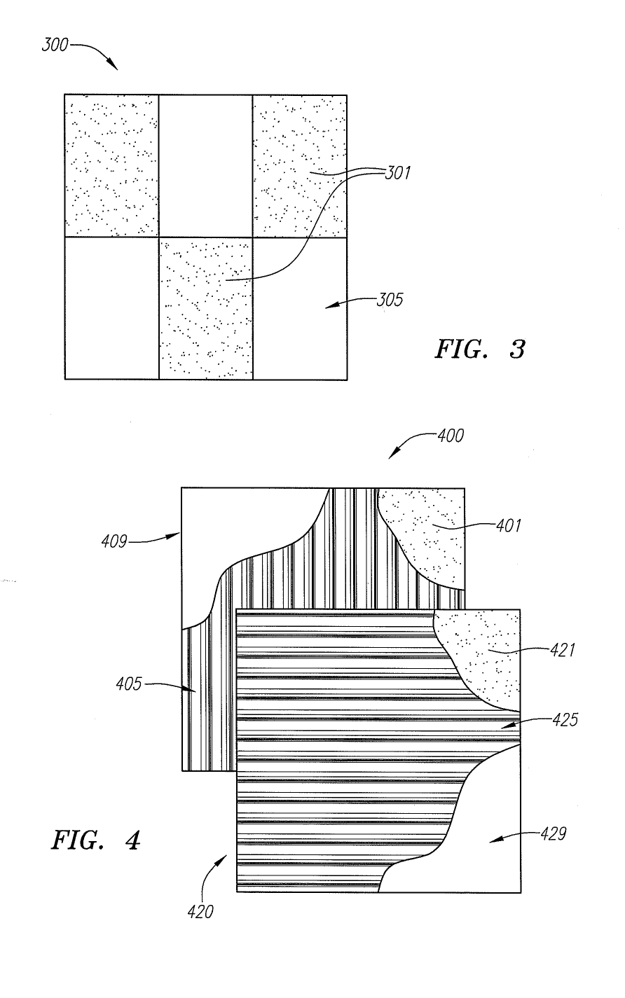

FIG. 3 is a diagram showing different surface textures or variations of an aluminum foil board 300. For example, the aluminum foil board 300 may include a first plurality of sections 301 of a first colorized foil (e.g., gold) having a variegated pattern, bearing perforations, or having other textural variations (creases, wrinkles, waves, or the like), and a second plurality of sections 305 having a second colorized foil (e.g., silver) having a smooth or “hard” pattern. The pattern of sections 301, 305 of the different colored/textured foils may be repeating or symmetrical, as shown in FIG. 3, or else may be asymmetric or random in various respects. For example, the sections 301, 305 may be arranged in a checkerboard pattern. The sections 301, 305 may also be of the same size or different sizes. More than two different types, colorations, textures, etc. of foil may be used.

FIG. 4 is a diagram of partial cutaway views of a pair of aluminum foil boards 400, 420 in accordance with another embodiment. In the example of FIG. 4A, each aluminum foil board 400, 420 may be constructed similar to the embodiment of FIGS. 1A-1B. That is, the first aluminum foil board 400 may comprise a first outside layer 401 of flat aluminum foil, a middle layer 405 of corrugated, bent or folded aluminum foil, and a second outer layer 409 of flat aluminum foil, arranged such that the middle layer 405 is sandwiched between the first outside layer 401 and second outside layer 409 of aluminum foil. The second aluminum foil board 420 may likewise comprise a first outside layer 421 of flat aluminum foil, a middle layer 425 of corrugated, bent or folded aluminum foil, and a second outer layer 429 of flat aluminum foil, arranged such that the middle layer 425 is sandwiched between the first outside layer 421 and second outside layer 429 of aluminum foil. As with FIG. 1A, the outside layers 401, 409 or 421, 429 may be affixed to the middle layer 405 or 425, respectively, by welding, heat-resistant adhesive, or other means.

In the example of FIG. 4, each of the pair of aluminum foil boards 400, 420 is provided with a different outer foil material (in terms of color, shape, texture, etc.), so as to provide a variety of reflective surface options from only two aluminum foil boards 400, 420. For example, the first aluminum foil board 400 may have a first outside layer 401 (i.e., front surface) of aluminum or hard silver (dull), and a second outside layer 409 (i.e. back surface) of variegated soft silver. The second aluminum foil board 420 may have a first outside layer 421 (i.e., front surface) of aluminum or hard silver (shiny), and a second outside layer 429 (i.e. back surface) of variegated /soft gold. The pair of aluminum foil boards 400, 420 may be affixed together front-to-back, front-to-front, or back-to-back to create a total of four different reflective combinations. The aluminum foil boards 400, 420 may be affixed together by, e.g., duct tape, electrical tape, aluminum foil tape, clips, staples, etc. If affixed together with corrugations in the same direction, the resulting foam board pair may be rollable or bendable, and if affixed with corrugations in perpendicular directions, the resulting foam board pair would be generally rigid and inflexible. These various options may provide a lighting engineer or technician with a substantial number of options for creating different lighting effects using the reflectivity of the desired foam board pairing. Similarly, the aluminum foil board pair may be affixed to create a rigid structure for use on a set, while taken apart and rolled up for ease of transport or storage when not in use.

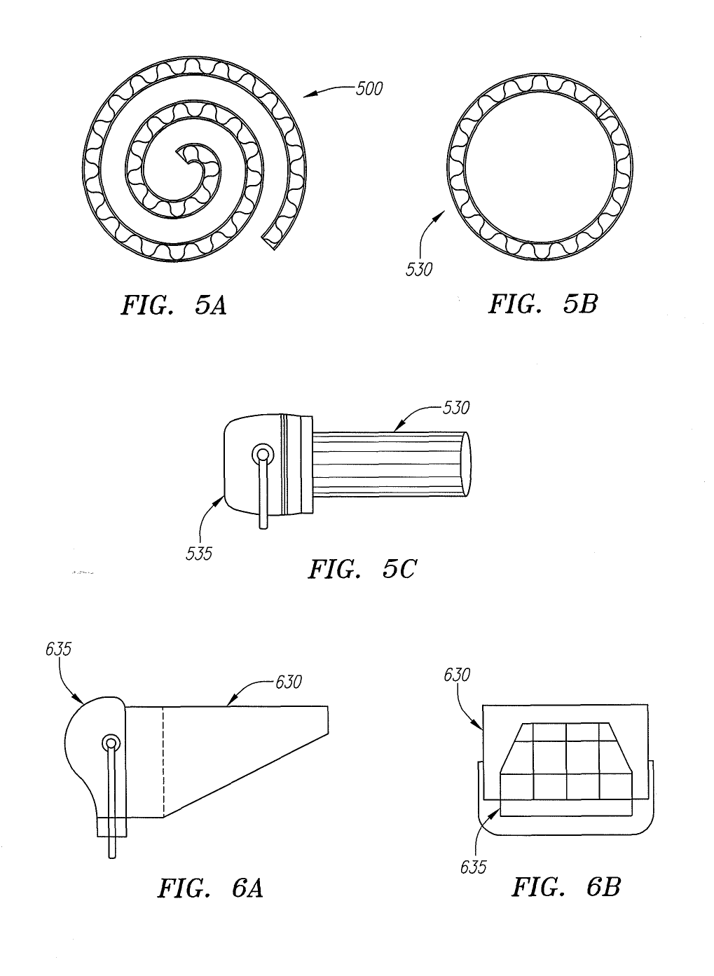

FIG. 5A is a side view diagram of an aluminum foil board 500 that has been rolled into a more compact size.

FIG. 5B is a side view diagram of an aluminum foil board 530 that has been rolled into the shape of a snoot, and FIG. 5C shows the rolled snoot 530 of FIG. 5B attached to a lighting fixture 535. The aluminum foil board 530 may be held together at the ends by, e.g., duct tape, electrical tape, aluminum foil tape, clips, staples, etc., thus keeping it in the rolled shape. The rolled aluminum foil board 530 may be attached to the lighting fixture 535 by any suitable means, including spring clamps, grip clips, binder clips, clothes pins, etc.

FIGS. 6A and 6B are side and front view diagrams, respectively, showing a generally box-shaped snoot 630 fashioned from a rigid aluminum foil board and attached to a yoke-mounted multi-light lighting fixture 635. In FIGS. 6A and 6B, multiple pieces of aluminum foil board have been cut into the various sides, top and bottom of the box-shaped snoot 630, and attached using heat resistant adhesive, welding, metal clips, wire rings, staples, or other means such as duct tape, electrical tape, aluminum foil tape, etc. In this example, the aluminum foil boards are preferably rigid in nature, constructed in accordance with the embodiment of FIG. 2A. The resulting box-shaped snoot 630 provided a non-flammable, lightweight, maneuverable and versatile lighting control mechanism, for directing and channeling light from the lighting fixture 635, as well as creating various effects due to different possible reflective surfaces that can be used to construct the aluminum foil board that forms the sides, bottom and top of the snoot 630.

The material used to create the aluminum foil boards described herein may be manufactured much like cardboard. For example, the aluminum foil may first be corrugated (bent) in a possibly wave (or folded up like a fan) type pattern to achieve increased rigidity. One, two or more sheets of this shaped material (or materials), possibly layered at intersecting or crossing angles, and, if desired, sandwiched between flat foil or other material, create a rigid, lightweight fire resistant material with many advantages for the entertainment industry and possibly other use. Various surface effects can be achieved by texturing, laminating, dying , painting or anodizing the outer surface(s) of the aluminum foil board. The term “aluminum foil” is meant to include all of the foregoing variations, as well as alloys made primarily from aluminum but also containing other materials (e.g., tin, copper, magnesium, etc.) Perforation may be advantageous in certain applications to reduce weight and allow wind to pass through for outdoor reflector type use. The aluminum foil material is generally waterproof and is also an efficient reflector/absorber/radiator of light/heat energy, thus providing significant other potential uses in packaging, fluorescent light housings, model making or other applications. Variations in the direction of the corrugated wafers can be used to control rigidity for various applications. It may also be advantageous to incorporate aluminum wires to increase strength or mold ability. Introduction of PVC or other materials may be advantageous to reduce electrical conductivity, control audible properties during use or when cutting, or affect other attributes. For example, the aluminum foil board may need to be cut into shapes (e.g., with a razor knife) while on a motion picture or television production set during a shoot, and excessive noise created by cutting the material could adversely impact the production.

Such a product comprising aluminum foil or other lightweight fire resistant materials that can be self supporting (rigid) and can hold a shape or form can create a lightweight lighting accessory comprising a full or partial channel for channeling, reflecting, directing, enclosing, stopping or redirecting light from an illumination source used in television or motion picture filming or video. Such enclosure, reflector or accessory as described may be formed of one or more walls (boards) having two outer layers with a third (or more) layer(s) therebetween, wherein the outer layer(s) have a metallic (reflective/heat resistant) surface and the third or additional layers between provide structural support for the two outer layers.

In some applications, the foil board may be constructed in a form that can “roll up”. By providing ridges (or scores) along only one length it is possible to roll up the material for shipping or storage. Affixing (sandwiching) two or more pieces together with the ridges juxtaposed allows the construction of a rigid and flat “board ” when affixed but a compact rolled-up material when non affixed. The ability to roll up the foil board material could also be advantageous in creating cylindrical shaped “snoots” for use to shape the light from a lighting instrument.

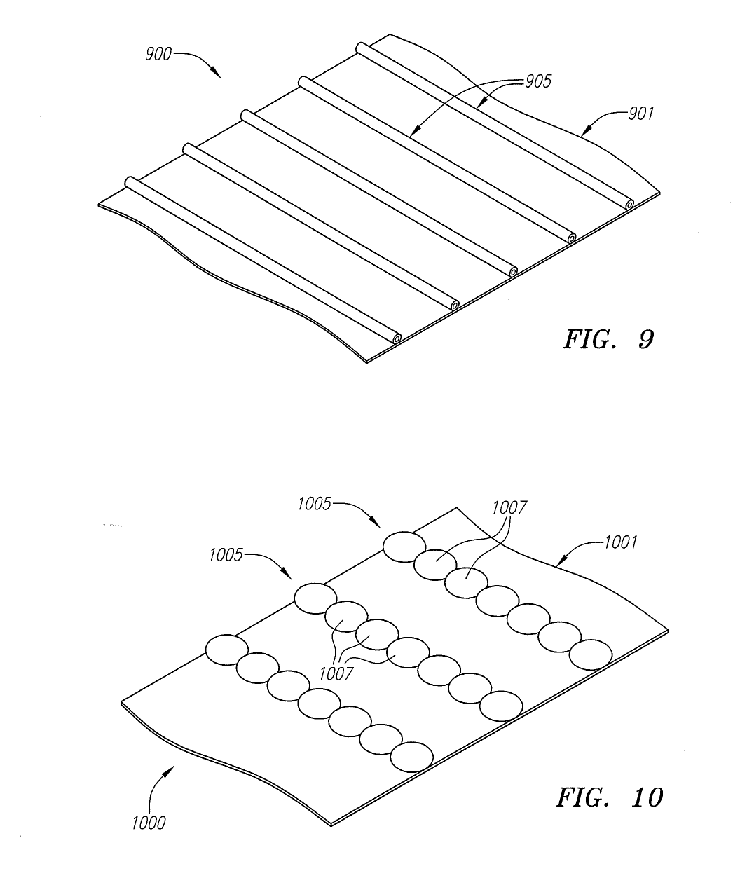

FIG. 9 is a diagram of a reinforced aluminum sheet as may be used in an aluminum foil board in various embodiments. In FIG. 9, a pattern of rolled aluminum wirelike ropes 905, each formed from rolled aluminum foil, are spaced along an aluminum foil sheet 901 or other backing A second aluminum foil sheet (not shown) may be placed on top of the aluminum wirelike ropes 905, forming a sandwich structure similar to FIG. 1A. For additional strength, another set of rolled aluminum wirelike ropes may be placed perpendicular to the ropes 905 shown in FIG. 9, thus forming a criss-cross of interlaced pattern.

FIG. 10 is a diagram of another embodiment as disclosed herein. In FIG. 10, a pattern of air-filled aluminum bubbles 1007 are spaced in equidistant lines 1005 across an aluminum foil sheet 1001 to provide structural support. A second aluminum foil sheet (not shown) may be placed on top of the air-filled aluminum bubbles 1007, forming a sandwich structure similar to FIG. 1A.

In some embodiments, it may be desirable to have the back side of the aluminum foil board made of a different material than aluminum, e.g., from a plastic laminate, an adhesive paper, poster board, or other material. Also, in some cases it may be desirable to include additional intervening layers of material in the interior of the aluminum foil board, including thin cardboard, poster board, plastic or the like.

Many embodiments of a corrugated aluminum foil board as described herein may provide environmental benefits in addition to the other aforementioned benefits. For example, the aluminum foil board may be manufactured entirely or substantial part from recycled material, and may also itself by entirely or substantially recyclable.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

What is claimed is:

1. An aluminum foil board product, comprising:
a first sheet of aluminum foil;
a corrugated aluminum foil layer;
a second sheet of material;
wherein the corrugated aluminum foil layer is sandwiched between the first sheet of aluminum foil and the second sheet of material.

2. The product of claim 1, wherein said second sheet of material is aluminum foil.

3. The product of claim 1, having a reflective aluminum surface on one or more outer sides.

4. The product of claim 1, having a darkened non-reflective surface on one or more outer sides.

5. The product of claim 1, having a variegated surface texture on one or more outer sides.

6. The product of claim 1, having a surface color for modifying the color characteristics or quality of the reflected light.

7. The product of claim 1, wherein the first sheet of aluminum foil, the corrugated aluminum foil layer, and the second sheet of material collectively form a relatively rigid structure.

8. The product of claim 1, wherein said first sheet of aluminum foil comprises a plurality of textures or colorized sections arranged in a repeating pattern.

9. The product of claim 1, further comprising a second corrugated aluminum foil layer, stacked with the first corrugated aluminum foil layer such that the corrugations of the first and second corrugated aluminum foil layers are at cross-angles to provide increased strength or rigidity.

10. The product of claim 1, further comprising metal wires between said first sheet of aluminum material and second sheet of material for reinforcement.

11. The product of claim 1, wherein the first sheet of aluminum foil, the corrugated aluminum foil layer, and the second sheet of material collectively form a composite structure that is easily cut with a razor knife.

12. The product of claim 1, wherein the first sheet of aluminum foil, the corrugated aluminum foil layer, and the second sheet of material collectively form a composite structure that is can be rolled.

13. The product of claim 1, further comprising a non-conductive material coating over the first sheet of aluminum foil or the second sheet of material.

14. The product of claim 1, wherein the first sheet of aluminum foil, the corrugated aluminum foil layer, and the second sheet of material collectively form a composite structure that is both water resistant and fire resistant.

15. A method for manufacturing an aluminum foil board product, comprising the steps of:
forming an aluminum foil sheet into a corrugated aluminum foil layer having a front side and a back side;
affixing the front side of the corrugated aluminum foil layer to a first sheet of aluminum foil; and
affixing the back side of the corrugated aluminum foil layer to a second sheet of material, thereby sandwiching the corrugated aluminum foil layer between the first sheet of aluminum foil and the second sheet of material;
whereby a composite structure of increased strength and rigidity is formed.

16. The method of claim 15, wherein said second sheet of material is aluminum foil.

17. The method of claim 15, further comprising:
forming a second aluminum foil sheet into a second corrugated aluminum foil layer; and
stacking the second corrugated aluminum foil layer with the first corrugated aluminum foil layer such that the corrugations of the first and second corrugated aluminum foil layers are at cross-angles to provide increased strength or rigidity.

18. The method of claim 15, wherein one or more of the outer sides of the composite structure are highly reflective.

19. A lighting accessory, comprising:
a housing for channeling or directing illumination from a lighting fixture, said housing having one or more reflective surfaces;
said housing comprising a plurality of panels, at least one of said panels constructed from a first sheet of aluminum foil, a corrugated aluminum foil layer, and a second sheet of material, wherein the corrugated aluminum foil layer is sandwiched between the first sheet of aluminum foil and the second sheet of material.
